(19) United States
(12) Patent Application Publication
(10) Pub. No.: US 2008/0071804 A1
(43) Pub. Date: Mar. 20, 2008

(54) FILE SYSTEM ACCESS CONTROL BETWEEN MULTIPLE CLUSTERS

(75) Inventors: Kalyan C. Gunda, Wappingers Falls, NY (US); Eugene Johnson, Austin, TX (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/532,413

(22) Filed: Sep. 15, 2006

(51) Int. Cl. G06F 7/00

(52) U.S. Cl. 707/100

(57) ABSTRACT

Disclosed are a method, information processing system, and computer readable medium for managing filesystem access control between a plurality of clusters. The method includes receiving, on a node in a home cluster, a request from a remote cluster. The request includes information to access a given filesystem managed by the node. The given filesystem is one of a plurality of filesystems in the home cluster. The information in the request is compared with a local data repository comprising data entries regarding the file system. In response to the information in the request matching the data entries in the file system, the remote cluster is granted access permission to the file managed by the node in the home cluster.

### FIELD OF THE INVENTION

The present invention generally relates to the field of distributed processing systems, and more particularly relates to controlling access to filesystems by multiple distributed clusters.

### BACKGROUND OF THE INVENTION

Many modern processing systems include multiple processors. These multiple processors are frequently organized as groups and all of the members or nodes within the group operate in a cooperative manner. An example of a tightly integrated group of processors is a multiple processor computing cluster. One or more of these processors within a group can be referred to as a “node,” where a node is defined as one or more processors that are executing a single operating system image. A node that is part of a group is referred to herein as a member of the group or a member node. The various members within a group are connected by a data communications system that supports data communications among all of the group members.

Besides nodes, a cluster can also comprise disks and filesystems. A filesystem can be thought of as a collection of files or data structures. In other words, a filesystem can be logical and/or physical. A logical filesystem is a hierarchical structure comprises of interconnected directories. These directories include files that can be accessed by a cluster node. A physical filesystem comprises the physical files accessible by a cluster node. One example of a filesystem is a general parallel filesystem (“GPFS”). The GPFS is based on a shared disk model and runs in a distributed cluster. A set of nodes are grouped together to make a GPFS cluster, also considered as an administrative domain. When a filesystem is created in this cluster, it is mountable by all nodes in the cluster. In a GPFS cluster and other distributed clusters once a cluster is shared, all of its resources are shared with other clusters.

Currently, a mechanism to allow/disallow selective remote clusters to access one or more file systems of a home cluster does not exist. For example, with current GPFS system, when a remote node mounts a filesystem, it joins the home cluster. Therefore, all of the nodes in remote cluster have access to all filesystems in the home cluster. Current GPFS systems cannot prevent remote clusters from accessing select filesystems.

Therefore a need exists to overcome the problems with the prior art as discussed above.

### SUMMARY OF THE INVENTION

Briefly, in accordance with the present invention, disclosed are a method, information processing system, and computer readable medium for managing filesystem access control between a plurality of clusters. The method includes receiving, on a node in a home cluster, a request from a remote cluster. The request includes information to access a given filesystem managed by the node. The given filesystem is one of a plurality of filesystems in the home cluster. The information in the request is compared with a local data repository comprising data entries regarding the file system. In response to the information in the request matching the data entries in the file system, the remote cluster is granted access permission to the file managed by the node in the home cluster.

In another embodiment an information processing system within a distributed processing cluster system for managing filesystem access control between a plurality of clusters is disclosed. The information processing system comprises a memory and a processor communicatively coupled to the memory. A filesystem access manager is communicatively coupled to the memory and processor. The filesystem access manager is for receiving a request from a remote cluster. The request includes information to access a given filesystem managed by the node. The given filesystem is one of a plurality of filesystems in the home cluster. The information in the request is compared with a local data repository comprising data entries regarding the file system. In response to the information in the request matching the data entries in the file system, the remote cluster is granted access permission to the file managed by the node in the home cluster.

In yet another embodiment, a computer readable medium for managing filesystem access control between a plurality of clusters is disclosed. The computer readable medium comprises instructions for receiving, on a node in a home cluster, a request from a remote cluster. The request includes information to access a given filesystem managed by the node. The given filesystem is one of a plurality of filesystems in the home cluster. The information in the request is compared with a local data repository comprising data entries regarding the file system. In response to the information in the request matching the data entries in the file system, the remote cluster is granted access permission to the file managed by the node in the home cluster.

One advantage of the present invention is that it provides a mechanism for a home cluster to selectively allow/disallow remote clusters from accessing one or more filesystems. A home cluster can include a plurality of filesystems, each comprising its own permission and access list. Additionally, a filesystem in a home cluster can have different permissions and access rights for different clusters. Therefore, the present invention provides granular access control for filesystems in a cluster.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating exemplary distributing processing cluster system according to an embodiment of the present invention;

FIG. 2 is an exemplary filesystem access table according to an embodiment of the present invention;

FIG. 3 is a block diagram illustrating the overall system architecture of the distributed processing cluster system of FIG. 1 according to an embodiment of the present invention;

FIG. 4 is a more detailed view of a processing node in the distributed processing cluster system of FIG. 1 according to an embodiment of the present invention;

FIG. 5 is an operational flow diagram illustrating an exemplary process of assigning access rights to various remote clusters for a given filesystem according to an embodiment of the present invention; and

FIG. 6 is an operational flow diagram illustrating an exemplary process of controlling access to a given filesystem according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Distributed Processing Cluster System

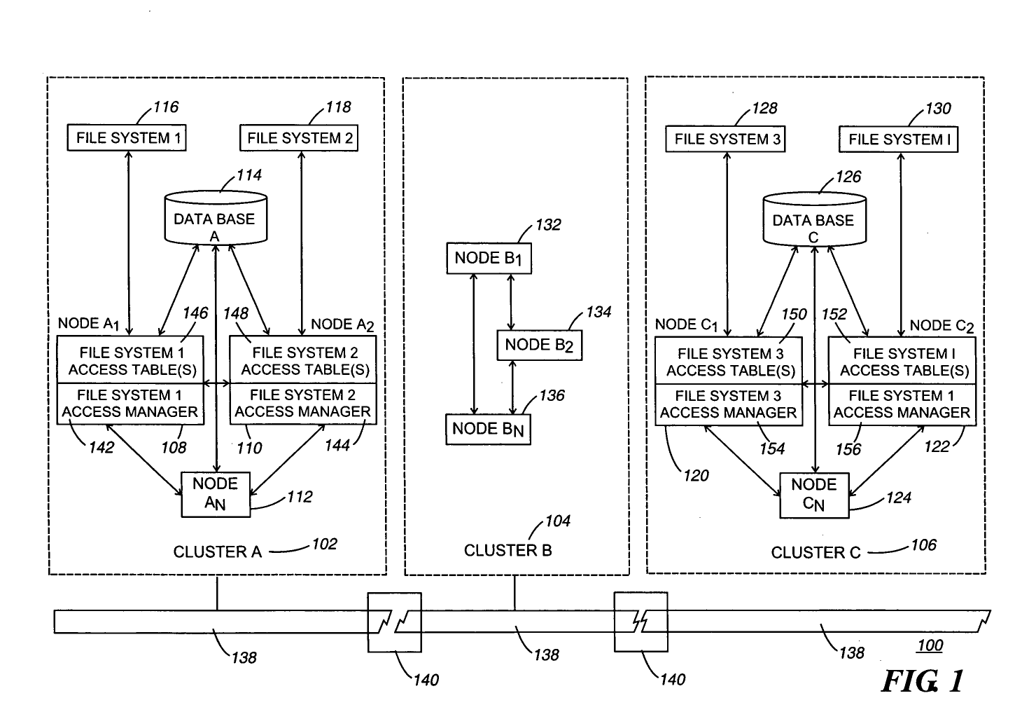

According to an embodiment of the present invention, as shown in FIG. 1, an exemplary distributed processing cluster system 100 is shown. The distributed processing cluster system 100 shows three clusters/sites, Cluster A 102, Cluster B 104, and Cluster C 106. Embodiments of the present invention operate with distributed processing cluster systems that have any number of sites, from one to as many as are practical. The clusters as used in this example are defined to be a group of processing nodes that have access to resources that are within one resource pool. For example, the nodes within Cluster A 102, i.e., Node A₁ 108, Node A₂ 110, and Node Aₙ 112, have access to a database 114 and filesystems 116, 118. Similarly, the nodes within Cluster C 106, i.e., Node C₁ 120, Node C₂ 122, and Node Cₙ 124 have access to the database 126 and filesystems 128, 130. Cluster B 104 also includes nodes such as Node B₁ 132, Node B2 134, and Node Bₙ 136. Cluster B 104 can also include resources such as a database and/or filesystem. However, these components are not shown in FIG. 1 for simplicity.

The nodes of each cluster are connected via a data communications network 138 that supports data communications between nodes that are part of the same cluster and that are part of different clusters. In this example, the clusters are geographically removed from each other and are interconnected by an inter-cluster communications system 140. The inter-cluster communications system 140 connects the normally higher speed data communications network 138 that is included within each cluster.

The inter-cluster communications system 140 of the exemplary embodiment utilizes a high speed connection. Embodiments of the present invention utilize various inter-cluster communications systems 140 such as conventional WAN architectures, landline, terrestrial and satellite radio links and other communications techniques. Embodiments of the present invention also operate with any number of clusters that have similar interconnections so as to form a continuous communications network between all nodes of the clusters. Embodiments of the present invention also include “clusters” that are physically close to each other, but that have processing nodes that do not have access to resources in the same resource pool. Physically close clusters are able to share a single data communications network 138 and not include a separate inter-cluster communications system 140.

Other resources that can be included within a cluster but that are not shown in FIG. 1 are data storage devices, printers, and other peripherals that are controlled by one node within the group. In the exemplary embodiments, a node is equivalent to a member of a distributed processing cluster system. As discussed above, a cluster can comprise a filesystem such as filesystem 1 116 and filesystem 2 118. In one embodiment, are GPFS filesystems. The nodes within a cluster such as Node A₁ 108, Node A₂ 110, and Node Aₙ 112 make up a GPFS cluster. Each cluster 102, 104, 106 comprises a plurality of storage disks (not shown) that include files. One or more of these storage disks can be coupled together to form a filesystem. In other words, the files within a storage disk can be logically grouped together to form a filesystem that is accessible by nodes in a cluster.

Information associated with these storage disks such as disk name and the server where the disk is located can reside within the database 114, 126. Each node 108, 110, 112, within a cluster 102 has access to the same information. For example, the information residing in the database 114 and the filesystems 116, 118 is accessible by each node 108, 110, 112 in the cluster 108. Each filesystem 116, 118 in a cluster 102 is managed by one or more of the nodes. For example, the filesystem 1 116 is managed by Node A₁ 108 and the filesystem 2 118 is managed by Node A₂ 110. In other words, Node A₁ 108 created the filesystem 1 116 and Node A₂ 110 created the filesystem 2 118. Each managing node 108, 110 comprises a filesystem access manager for managing its given filesystem 116, 118. The managing nodes 120, 122 of Cluster C 106 also include filesystem access managers 150, 152 for managing filesystem 3 128 and filesystem 1130, respectively.

The filesystem managers 142, 144 allow for selective and dynamic access control to the respective filesystem 116, 118. For example, when an administrator of a managing node such as Node A₁ 108 creates a filesystem 116, the administrator identifies the other clusters 104, 106 existing in the distributed processing cluster system 100. Through the filesystem access manager 142, the administrator can set different permissions and access rights for each remote cluster 104, 106 with respect to the filesystem 1 116. Permissions either grant or deny a user access to a filesystem. Access rights define the type access such as read, write, or read and write that a remote cluster has with respect to a filesystem. A remote cluster is defined as a cluster not comprising the filesystem to be accessed. A home cluster is defined as a cluster comprising the filesystem to be accessed. It should be noted that permissions and access rights can be granted/denied manually by an administrator through a filesystem access manager or automatically by the filesystem access manager itself. It should be noted that in additional embodiments, a node within a cluster can set permissions and access rights and not just a managing node. In these embodiments, the managing nodes only enforce the permissions and access rights.

With respect to filesystem 1 116, the filesystem 1 access manager 142 can deny access to filesystem 1 116 to Cluster C 106, but grant access to filesystem 1 116 to Cluster B 104. If a cluster is granted access to a filesystem, each node within the cluster has access to the filesystem. Similarly if a cluster is denied access to a filesystem, each node within that cluster is also denied access to the filesystem. As can be seen from FIG. 1, a cluster can comprise a plurality of filesystems. For example, Cluster A 102 includes filesystem 1 116 and filesystem 2 118. The filesystem 2 access manager 144 can set permissions and access rights independent of the permissions and access rights associated with filesystem 1. For example, even though Cluster C 106 is denied access to filesystem 1 116, the filesystem 2 access manager 118 can grant Cluster C 106 access to filesystem 2 118. Additionally, if Cluster B 104 was granted read access to filesystem 1 116, Cluster B can have read/write access to filesystem 2 118. Also, the permissions and access rights of remote clusters can be dynamically changed by a filesystem access manager. A dynamic update can be performed without requiring a node within a remote cluster to remount the filesystem.

Permissions and access rights for remote clusters can be stored in the database 114. For example, a filesystem access table(s) associated with each filesystem 116, 118 created when a filesystem is created. Alternatively, a master filesystem access table can be created that comprises access right information for each filesystem in the cluster. As the filesystem access manager creates permissions and access rights the filesystem access table(s) is updated. A managing node 108, 110 accesses these tables when determining if a requesting remote node has permissions and access rights for a given filesystem. The information associated with filesystem access table can be streamed from the database 114 or the managing node 108, 110 can keep a local copy such as filesystem 1 access table(s) 146 and filesystem access table(s) 148 shown in FIG. 1.

Now consider an example where Cluster A 102 is a home cluster and Cluster B 104 is a remote cluster. In other words, Cluster A 102 comprises a filesystem that one or more nodes in Cluster B 106 want to access. When Cluster A receives a request from a node in Cluster B such as Node B₁ 132 for mounting filesystem 1 116, Node A₁, which is the managing node of filesystem 1 116, analyzes the request. A request for mounting a filesystem can include, but is not limited to, a filesystem identifier, a requesting node identifier, and the like. The filesystem identifier notifies the home cluster of which filesystem that the remote node wants to access and the requesting node identifier helps the managing node authenticate the requesting node. For example, Node A₁ communicates with Cluster B 106 to verify that Node B₁ is authenticated. Node A₁ 108 then analyzes the filesystem 1 access table 146 to determine whether Node B₁ 132 has permission to access the filesystem 1. If Node B₁ 132 does not have permission, the Node A₁ 108 denies the mounting request.

If Node B₁ 132 has permission, Node A₁ 108 then grants the mounting request. However, in some instances, the remote node might request access that it does not have. For example, if Node B₁ 132 only has read access to the filesystem 1 116 but request write access, Node A₁ 108 can either deny the request or allow the request, but only for the authorized access of reading. If the request is denied Node A₁ 108 can notify Node B₁ 132 of the reasons it was denied and specify what access rights Node B₁ 132 so it can resubmit its request with the correct access type.

Exemplary Filesystem Access Table

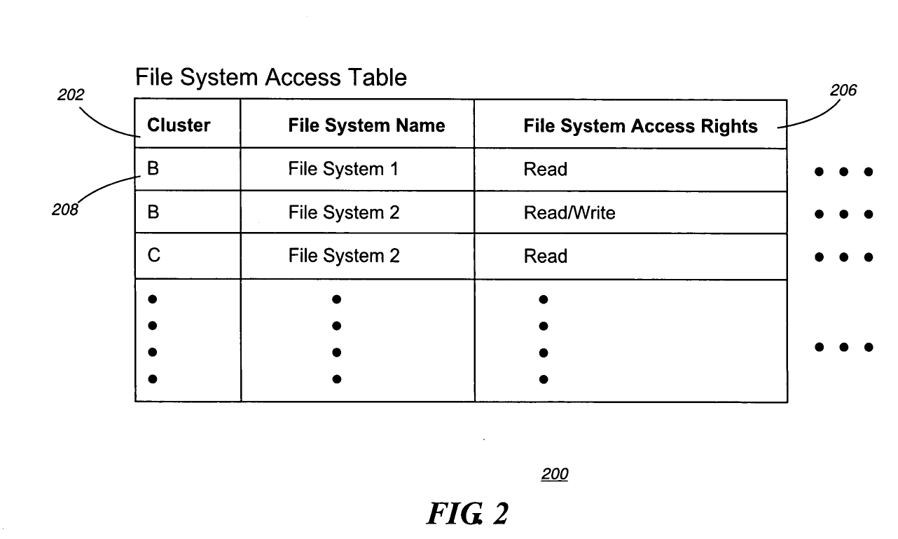

FIG. 2 illustrates an exemplary filesystem access table 200. The filesystem access table 200 is similar to the filesystem access tables 146, 148, 150, 152 discussed above. FIG. 2 shows the filesystem access table 200 as being a master filesystem access table. In other words, the filesystem access table 200 comprises access rights for all of the filesystems in a cluster. Alternatively, a separate filesystem access table can be created for each filesystem within a cluster. For example, in FIG. 1 a separate filesystem access table can be created for filesystem 1 116 and filesystem 2 118.

The filesystem access table 200, in one embodiment, comprises various columns such as a “Cluster” column 202, a “Filesystem Name” column 204, and a “Filesystem Access Rights” column 206. The Cluster column 202 comprises the identity of a cluster. For example, a first entry 208 under the Cluster column 202 includes “B” for identifying cluster B 104. The Filesystem Name column 204 comprises entries including a filesystem identifier. For example, a first entry 210 under the Filesystem Name column 204 includes “Filesystem 1” for identifying filesystem 1 116. The “Filesystem Access Rights” column 206 includes entries for identifying the access right of a cluster identified under the Cluster column 202 for a given filesystem under the Filesystem Name column 204.

For example, FIG. 2 shows that Cluster B 104 has read access for filesystem 1 116. The filesystem access table 200 also shows that Cluster B 104 has read/write access for filesystem 2 118 and Cluster C 106 has read access for filesystem 2 118. In the example of FIG. 2, if a cluster is not listed in the filesystem table 200 then it does not have permission to access a filesystem. For example, in FIG. 2 Cluster C 106 is not listed as having access rights for filesystem 2 118. Therefore, if Cluster C sends a mounting request to Node B₁ 132, the request is denied. However, a managing node can dynamically give or take away access rights. So the filesystem access table 200 can be dynamically updated to reflect access right changes. As can be seen from FIG. 2, different remote clusters can have different access rights for the various filesystems in a home cluster.

Additionally, the filesystem access table 200 can also include every remote cluster identified as compared to only remote clusters having an access right type. In this embodiment, filesystem access table 200 can have an additional column labeled “Permission”, which indicates if a cluster has permission to access a listed filesystem. Therefore, in this embodiment, a node manager can directly determine if a cluster has rights as compared to negatively (i.e. the cluster does not exist in the table for a filesystem so therefore it does not have permission or rights) determining that rights do not exist for a cluster. It should be noted that other columns and information can be included within the filesystem access table 200 than what is shown in FIG. 2.

Exemplary Architecture For the Distribute Processing Cluster System

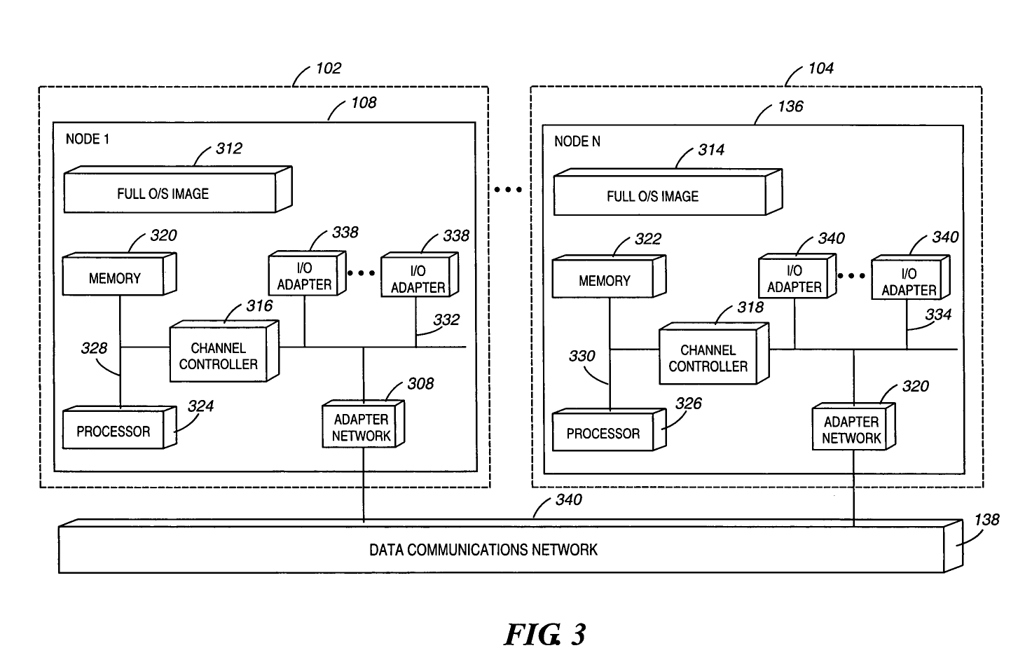

FIG. 3 is a block diagram illustrating an exemplary architecture for the distributed processing cluster system 100 of FIG. 1. FIG. 3 only shows one node 108, 136 for each cluster 102, 104 for simplicity. In one embodiment, the distributed processing cluster system 100 can operate in an SMP computing environment. The distributed processing cluster system 100 executes on a plurality of processing nodes 108, 136 coupled to one another node via a plurality of network adapters 308, 310. Each processing node 108, 136 is an independent computer with its own operating system image 312, 314, channel controller 316, 318, memory 320, 322, and processor(s) 324, 326 on a system memory bus 328, 330. A system input/output bus 332, 334 couples I/O adapters 338, 340 and network adapter 308, 310. Although only one processor 324, 326 is shown in each processing node 108, 136, each processing node 108, 136 is capable of having more than one processor. Each network adapter is linked together via the data communications network 138. All of these variations are considered a part of the claimed invention. It should be noted that the present invention is also applicable to a single information processing system.

Exemplary Information Processing System

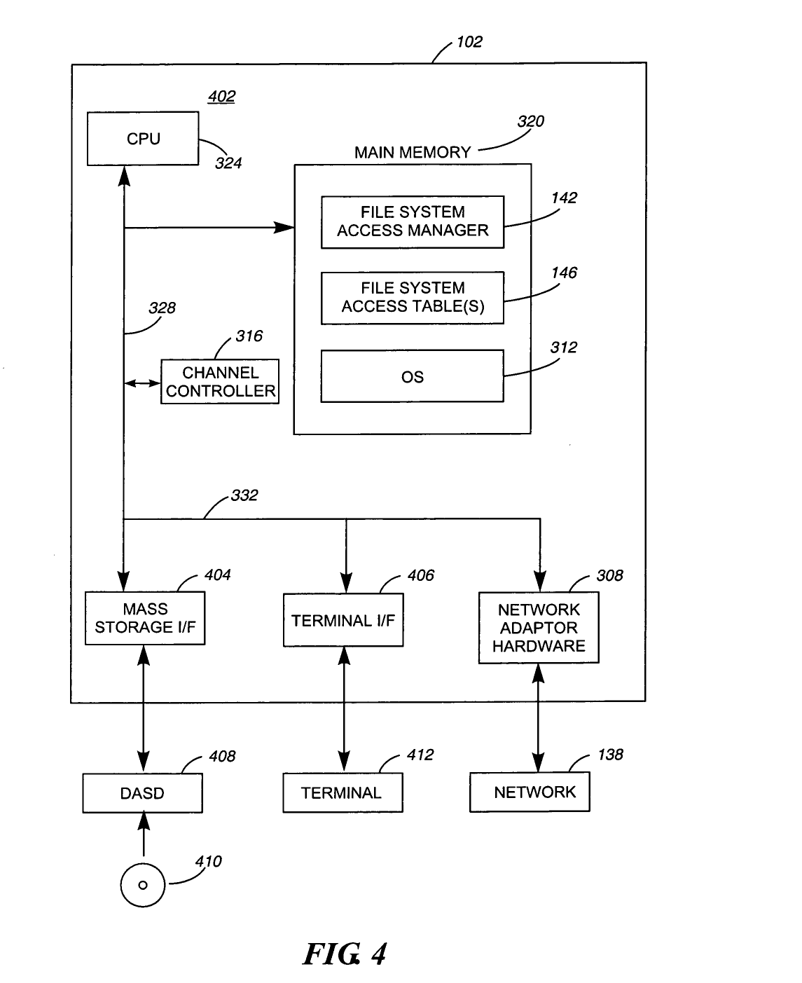

FIG. 4 is a block diagram illustrating a more detailed view of the processing node 108, which from hereon in is referred to as information processing system 108. The information processing system 108 is based upon a suitably configured processing system adapted to implement the exemplary embodiment of the present invention. Any suitably configured processing system is similarly able to be used as the information processing system 108 by embodiments of the present invention, for example, a personal computer, workstation, or the like. The information processing system 108 includes a computer 402. The computer 402 includes a processor 324, main memory 320, and a channel controller 316 on a system bus 328. A system input/output bus 332 couples a mass storage interface 404, a terminal interface 406 and network hardware 308. The mass storage interface 404 is used to connect mass storage devices such as data storage device 408 to the information processing system 108. One specific type of data storage device is a computer readable medium such as a CD drive or DVD drive, which may be used to store data to and read data from a CD 410 (or DVD). Another type of data storage device is a data storage device configured to support, for example, NTFS type file system operations.

The main memory 320, in one embodiment, includes the filesystem access manager 142 and a filesystem access table(s) 146, as discussed above. Although only one CPU 324 is illustrated for computer 402, computer systems with multiple CPUs can be used equally effectively. Embodiments of the present invention further incorporate interfaces that each includes separate, fully programmed microprocessors that are used to off-load processing from the CPU 324. The terminal interface 406 is used to directly connect the information processing system 104 with one or more terminals 412 to the information processing system 104 for providing a user interface to the computer 402. These terminals 412, which are able to be non-intelligent or fully programmable workstations, are used to allow system administrators and users to communicate with the information processing system 108. A terminal 412 is also able to consist of user interface and peripheral devices that are connected to computer 402.

An operating system image 312 included in the main memory 320 is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 108. The network adapter hardware 106 is used to provide an interface to the network 138. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via a CD/DVD, e.g. CD 410, or other form of recordable media, or via any type of electronic transmission mechanism.

Exemplary Process Of Assigning Filesystem Access Permission and Access Rights

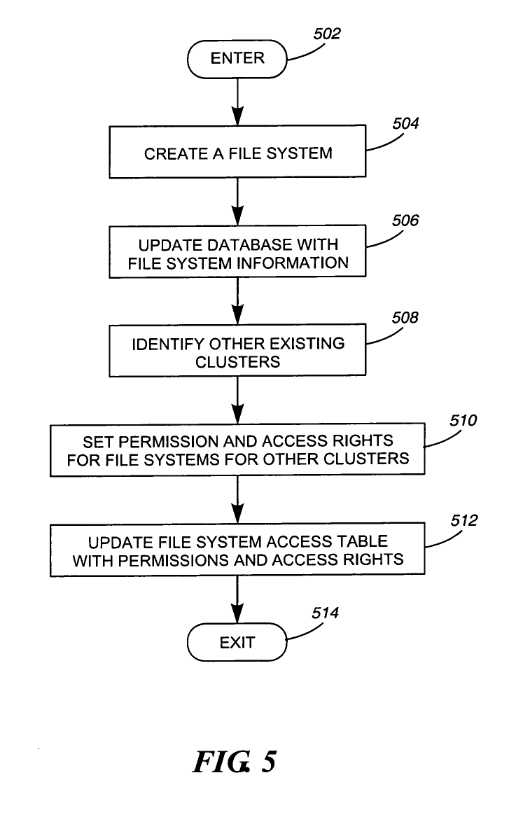

FIG. 5 illustrates an exemplary process for assigning filesystem permissions and access rights to multiple clusters. The operational flow diagram of FIG. 5 begins at step 502 and flows directly to step 504. A node within a cluster, at step 504, creates a filesystem. For example, Node A₁ 108 creates filesystem 1 116 and becomes its manager. The database 114, at step 506, is updated with information such as disk location and server name that is associated with the filesystem. The managing node, at step 508, identifies other clusters communicatively coupled to its cluster. The managing node, at step 510, via the filesystem access manager 142 sets permissions and access rights for given clusters.

For example, the filesystem access manager 142 can grant permission to select clusters for accessing to the filesystem, but deny other clusters permission to access. Additionally, the filesystem access manager 142 can grant different access rights to different remote clusters for a filesystem. Also a remote cluster can be granted a different permission and access rights for different filesystems within the home cluster. Once the permissions and access rights are set, the filesystem access manager 142, at step 512, updates the corresponding filesystem access table within the database 114. The control flow then exits at step 514.

Exemplary Process Of Controlling Access to A Filesystem

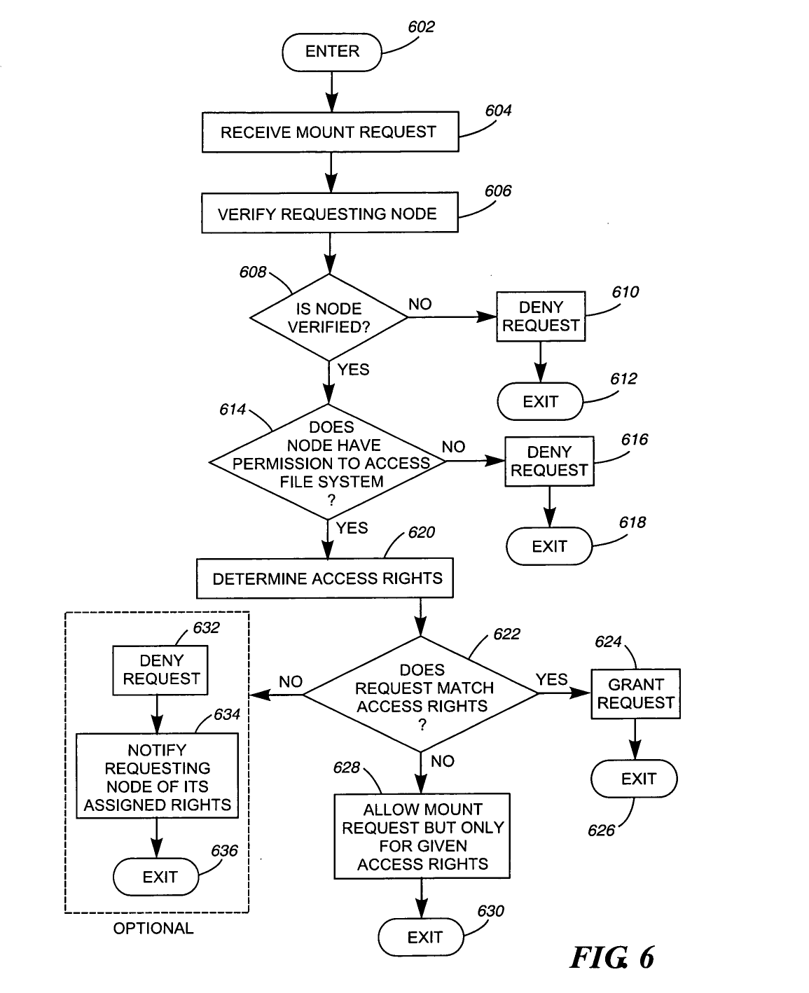

FIG. 6 illustrates an exemplary process for selectively controlling access to one or more filesystems. The operational flow diagram of FIG. 6 begins at step 602 and flows directly to step 604. A managing node, at step 604, receives a request from a remote node to mount the filesystem managed by the node. The managing node, at step 606, verifies the requesting node. For example, the managing node can contact the administrator of the requesting node's cluster to verify the authenticity of the requesting node. The managing node, at step 608, determines if the requesting node is verified. If the result of this determination is negative, the managing node, at step 610, denies the request. The control flow then exits at step 612.

If the result of this determination is positive, the managing node, at step 614, determines if the requesting node has permission to access the filesystem. For example, the managing node analyzes the filesystem access table to determine if the requesting node has been granted permission to access the filesystem. If the result of this determination is negative, the managing node, at step 616, denies the mounting request. The control flow exits at step 618.

If the result of this determination is positive, the managing node, at step 620 determines the access rights of the requesting node. For example, the managing node analyzes the filesystem access table to determine the access rights granted to the requesting node. The managing node, at step 622, determines if the mounting request matches the access type granted to the requesting node. For example, if the mounting request is for read access to the filesystem, the managing node analyzes the filesystem access table to determine if the requesting node has read access to the filesystem.

If the result of this determination is positive, the managing node, at step 624, grants the mounting request. The control flow exits at step 626. If the result of this determination is negative (e.g., the mounting request is for an access right not granted to the requesting node) the managing node, at step 628, allows the request, but only for the granted access right(s). For example, if the access right granted to the requesting node is for read access, but the mounting request is for read/write access, the managing node allows the request but only for the read access. The control flow exits at step 630. Alternatively, optional steps can be taken by the managing node as shown by the dashed box. If the request does not match the access rights granted to the requesting node, the managing node, at step 632, denies the request. The managing node, at step 634, notifies the requesting node of the denial and of its granted access rights. This allows the requesting node to resubmit its request with the correct access type request. The control flow exits at step 636.

Non-Limiting Examples

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method to manage filesystem access control between a plurality of clusters, the method on a node comprising:
receiving, on a node in a home cluster, a request from a remote cluster, the request including information to access a given filesystem managed by the node, wherein the given filesystem is one of a plurality of filesystems in the home cluster;
comparing the information in the request with a local data repository comprising data entries regarding the file system; and
in response to the information in the request matching the data entries in the file system, granting the remote cluster access permission to the file managed by the node in the home cluster.

2. The method of claim 1, further comprising:
assigning a first access right to the remote cluster for the given file system; and
assigning a second access right to at least one other remote cluster for the given file system.

3. The method of claim 2, further comprising:
assigning a third access right to the remote cluster for at least one other filesystem in the plurality of filesystem.

4. The method of claim 2, further comprising:
in response to the information in the request failing to match the data entries in the file system, denying the remote cluster access permission to the file managed by the node in the home cluster.

5. The method of claim 2, wherein the entries regarding the file system are entries within a table comprising access rights associated with at least one remote cluster.

6. The method of claim 2, wherein in response to the information in the request failing to match the data entries in the file system:
determining if the remote cluster is associated with at least one access right;
in response to the remote cluster being associated with at least one access right, determining that the request included an access right not granted to the remote cluster; and
allowing the request only for the access right associated with the remote cluster.

7. The method of claim 2, wherein in response to the information in the request failing to match the data entries in the file system:
determining if the remote cluster is associated with at least one access right;
in response to the remote cluster being associated with at least one access right, denying the request; and
notifying the remote cluster of that the request has been denied, wherein the notifying includes notifying the remote cluster of the access right associated with the remote cluster.

8. The method of claim 2, further comprising:
dynamically changing at least one of the first access right assigned to the remote cluster and the second access right assigned to the other remote cluster; and
enforcing the at least one of first access right assigned which has been changed and the at least second access right which has been changed without the remote cluster re-mounting the given filesystem.

9. The method of claim 2, wherein the information in the file request includes a name of the file system in the home cluster, at least one mount option, a name of the home cluster, and a name of the remote cluster.

10. A method to manage file system access control between a plurality of clusters, the method on a first node comprising:
coupling a data repository within a first cluster defining at least one remote cluster with permission to mount at least one remotely accessible file system that is a subset within a plurality of file systems in the first cluster;
receiving from a second node within a requesting remote cluster a request to mount the remotely accessible file system;
determining, based upon contents of the data repository, a permission of any node within the requesting remote cluster to mount the remotely accessible filesystem; and
permitting, in response to the determining, a mounting of the at least one remotely accessible file system by the second node.

11. An information processing system in a distributed processing cluster system for managing filesystem access control between a plurality of clusters, the information processing system comprising:
a memory;
a processor communicatively coupled to the memory; and
a filesystem access manager communicatively coupled to the memory and processor, wherein the filesystem access manager is for:
receiving a request from a remote cluster, the request including information to access a given filesystem managed by a node, wherein the given filesystem is one of a plurality of filesystems in a home cluster;
comparing the information in the request with a local data repository comprising data entries regarding the file system; and
in response to the information in the request matching the data entries in the file system, granting the remote cluster access permission to the file managed by the node in the home cluster.

12. The information processing system of claim 11, wherein the filesystem access manager is further for:
assigning a first access right to the remote cluster for the given file system; and
assigning a second access right to at least one other remote cluster for the given file system.

13. The information processing system of claim 12, wherein the filesystem access manager is further for:
assigning a third access right to the remote cluster for at least one other filesystem in the plurality of filesystem.

14. The information processing system of claim 12, wherein the filesystem access manager is further for:
in response to the information in the request failing to match the data entries in the file system, denying the remote cluster access permission to the file managed by the node in the home cluster.

15. The information processing system of claim 12, wherein in response to the information in the request failing to match the data entries in the file system:
determining if the remote cluster is associated with at least one access right;
in response to the remote cluster being associated with at least one access right, determining that the request included an access right not granted to the remote cluster; and
allowing the request only for the access right associated with the remote cluster.

16. A computer readable medium for managing filesystem access control between a plurality of clusters, the computer readable medium comprising instructions for:
receiving a request from a remote cluster, the request including information to access a given filesystem managed by a node, wherein the given filesystem is one of a plurality of filesystems in a home cluster;
comparing the information in the request with a local data repository comprising data entries regarding the file system; and
in response to the information in the request matching the data entries in the file system, granting the remote cluster access permission to the file managed by the node in the home cluster.

17. The computer readable medium of claim 16, further comprising instructions for:
assigning a first access right to the remote cluster for the given file system; and
assigning a second access right to at least one other remote cluster for the given file system.

18. The computer readable medium of claim 17, further comprising instructions for:
assigning a third access right to the remote cluster for at least one other filesystem in the plurality of filesystem.

19. The computer readable medium of claim 17, further comprising instructions for:
in response to the information in the request failing to match the data entries in the file system, denying the remote cluster access permission to the file managed by the node in the home cluster.

20. The computer readable medium of claim 17, wherein in response to the information in the request failing to match the data entries in the file system:
determining if the remote cluster is associated with at least one access right;
in response to the remote cluster being associated with at least one access right, determining that the request included an access right not granted to the remote cluster; and
allowing the request only for the access right associated with the remote cluster.
